(19) United States
(12) Patent Application Publication
(10) Pub. No.: US 2021/0081949 A1
(43) Pub. Date: Mar. 18, 2021

(54) FRAUD DETECTION BASED ON KNOWN USER IDENTIFICATION

(71) Applicant: MASTERCARD TECHNOLOGIES CANADA ULC, Vancouver (CA)

(72) Inventors: John Hearty, Vancouver (CA); Anton Laptiev, Vancouver (CA); Parin Prashant Shah, Vancouver (CA); Sik Suen Chan, Richmond (CA); Hanhan Wu, Surrey (CA)

(21) Appl. No.: 17/017,829

(22) Filed: Sep. 11, 2020

Related U.S. Application Data
(60) Provisional application No. 62/899,516, filed on Sep. 12, 2019.

(51) Int. Cl. G06Q 20/40; H04L 29/06; G06Q 20/16

(52) U.S. Cl. CPC G06Q 20/4016; H04L 63/0853; G06Q 20/16; G06Q 20/4018; H04L 63/0876

(57) ABSTRACT

Systems, methods, devices, and computer readable media for determining whether a transaction was initiated by a known user. Known users can be identified using a known user identification linear regression algorithm. The known user identification algorithm incorporates a variety of features of an initiated transaction, as well as reputation and historical data associated with an account or user, to produce a prediction value that indicates whether a user is a known user or whether there is a high potential for fraud. If the prediction value that results from the known user identification algorithm is greater than or equal to the threshold value, a fraud rule is triggered (i.e., predicted fraud). If the prediction value that results from the known user identification algorithm is less than the threshold value, the user who initiated the transaction is identified as a known user and the transaction is permitted to proceed (i.e., predicted non-fraud).

### RELATED APPLICATIONS

This application claims priority to U.S. Provisional Application No. 62/899,516, filed on Sep. 12, 2019, the entire contents of which are hereby incorporated by reference.

### FIELD

Embodiments described herein relate to fraud detection.

### BACKGROUND

Identifying known users associated with an initiated transaction is currently achieved using a rule-based solution. Such rule-based solutions utilize score bands, success, fraud lists, and endpoints (e.g., IP address) to identify a known user. Threshold values can be used to trigger the rules, and the threshold values can be manually adjusted to modify system performance.

### SUMMARY

By qualifying as a known user, greater efficiencies can result by, for example, not having to reenter certain information (e.g., a card verification value [“CVV”]) for each operation. If the entity who initiated a transaction does not qualify as known, that entity can be required to enter a valid CVV as part of an identification process to avoid false operations.

Embodiments described herein provide systems, methods, devices, and computer readable media for determining whether an operation/transaction was initiated by a known entity or user. Known users can be identified using a known user identification linear regression algorithm. The known user identification algorithm incorporates a variety of features of an initiated transaction, as well as reputation and historical data associated with an account or user, to produce a prediction value that indicates whether a user is a known user or whether there is a high potential for fraud. For example, if the prediction value that results from the known user identification algorithm is greater than or equal to the threshold value, a fraud rule is triggered (i.e., predicted fraud). If the prediction value that results from the known user identification algorithm is less than the threshold value, the user who initiated the transaction is identified as a known user and the transaction is permitted to proceed (i.e., predicted non-fraud).

One embodiment include a fraud detection system that may include a database and a server connected to the database. The server may be configured to determine whether an electronic transaction was initiated by a known user. The server may include an electronic processor and a memory. The server may be configured to receive a fraud analysis request related to the electronic transaction. The electronic transaction may include an associated plurality of features. The server may be further configured to determine values for the plurality of features for the electronic transaction. The server may be further configured to apply a weighted coefficient to each of the values of the plurality of features. The weighted coefficients may be related to an influence that each respective feature has on the electronic transaction potentially being a fraudulent transaction. The server may be further configured to determine a fraud prediction value based on the values of the plurality of features and the weighted coefficients. The server may be further configured to compare the fraud prediction value to a threshold value, and identify a user who initiated the electronic transaction as a known user when the fraud prediction value is less than the threshold value.

Another embodiment includes a method for detecting fraud during an electronic transaction by determining whether the electronic transaction was initiated by a known user. The method may include receiving, with a server, a fraud analysis request related to the electronic transaction. The electronic transaction may include an associated plurality of features. The server may be connected to a database and may include an electronic processor and a memory. The method may further include determining, with the server, values for the plurality of features for the electronic transaction. The method may further include applying, with the server, a weighted coefficient to each of the values of the plurality of features. The weighted coefficients may be related to an influence that each respective feature has on the electronic transaction potentially being a fraudulent transaction. The method may further include determining, with the server, a fraud prediction value based on the values of the plurality of features and the weighted coefficients. The method may further include comparing, with the server, the fraud prediction value to a threshold value, and identifying, with the server, a user who initiated the electronic transaction as a known user when the fraud prediction value is less than the threshold value.

Another embodiment includes at least one non-transitory computer-readable medium having encoded thereon instructions which, when executed by at least one electronic processor, may cause the at least one electronic processor to perform a method for detecting fraud during an electronic transaction by determining whether the electronic transaction was initiated by a known user. The method may include receiving, with a server, a fraud analysis request related to the electronic transaction. The electronic transaction may include an associated plurality of features. The server may be connected to a database and may include an electronic processor and a memory. The method may further include determining, with the server, values for the plurality of features for the electronic transaction. The method may further include applying, with the server, a weighted coefficient to each of the values of the plurality of features. The weighted coefficients may be related to an influence that each respective feature has on the electronic transaction potentially being a fraudulent transaction. The method may further include determining, with the server, a fraud prediction value based on the values of the plurality of features and the weighted coefficients. The method may further include comparing, with the server, the fraud prediction value to a threshold value, and identifying, with the server, a user who initiated the electronic transaction as a known user when the fraud prediction value is less than the threshold value.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components. Similarly, aspects herein that are described as implemented in software can, as recognized by one of ordinary skill in the art, be implemented in various forms of hardware.

Other aspects of the embodiments will become apparent by consideration of the detailed description and accompanying drawings.

### BRIEF DESCRIPTION OF THE DRAWINGS

FIG. 1 illustrates a fraud detection system, according to embodiments described herein.

FIG. 2 illustrates a server-side processing device of the system of FIG. 1, according to embodiments described herein.

FIG. 3 illustrates the fraud detection system of FIG. 1, according to embodiments described herein.

FIG. 4 illustrates a process for known user identification, according to embodiments described herein.

FIG. 5 illustrates an implementation of a linear regression algorithm for known user identification, according to embodiments described herein.

### DETAILED DESCRIPTION

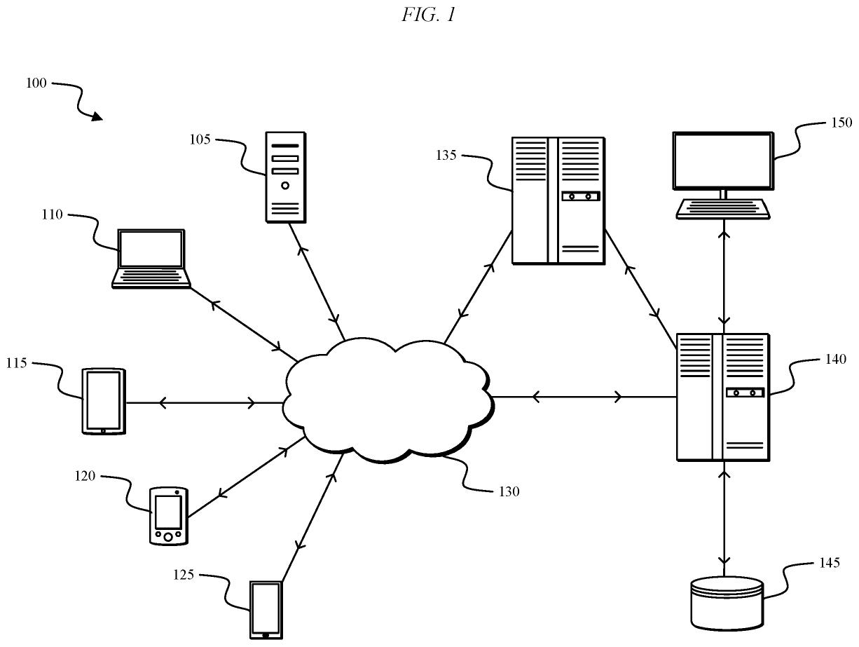

Embodiments described herein provide systems, methods, devices, and computer readable media for determining whether a transaction was initiated by a known user. FIG. 1 illustrates a fraud detection system 100. The system 100 includes a plurality of client-side devices 105-125, a network 130, a first server-side mainframe computer or server 135, a second server-side mainframe computer or server 140, a database 145, and a server-side user interface 150 (e.g., a workstation). The plurality of client-side devices 105-125 include, for example, a personal, desktop computer 105, a laptop computer 110, a tablet computer 115, a personal digital assistant (“PDA”) (e.g., an iPod touch, an e-reader, etc.) 120, and a mobile phone (e.g., a smart phone) 125. Each of the devices 105-125 is configured to communicatively connect to the server 135 or the server 140 through the network 130 and provide information to the server 135 or server 140 related to, for example, a transaction, a requested webpage, etc. Each of the devices 105-125 can request a webpage associated with a particular domain name, can attempt to login to an online service, can initiate a transaction, etc. The data sent to and received by visitors of a website will be generally referred to herein as client web traffic data. In the system 100 of FIG. 1, the server 135 represents a client server that is hosting a client website. Client web traffic data is produced as the devices 105-125 request access to webpages hosted by the server 135 or attempt to complete a transaction. The server 140 is connected to the server 135 and is configured to log and/or analyze the client web traffic data for the server 135. In some embodiments, the server 140 both hosts the client website and is configured to log and analyze the client web traffic data associated with the client website. In some embodiments, the server 140 is configured to store the logged client web traffic data in the database 145 for future retrieval and analysis. The workstation 150 can be used, for example, by an analyst to manually review and assess the logged client web traffic data, generate fraud detection rules, update fraud detection rules, etc. The logged client web traffic data includes a variety of attributes related to the devices interacting with the client website. For example, the attributes of the devices 105-125 include, among other things, IP address, user agent, operating system, browser, device ID, account ID, country of origin, time of day, etc. Attribute information received from the devices 105-125 at the server 135 can also be stored in the database 145.

The network 130 is, for example, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In some implementations, the network 130 is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, a 5G New Radio network, a Digital Enhanced Cordless Telecommunications (“DECT”) network, a Digital AMPS (“IS-136/TDMA”) network, or an Integrated Digital Enhanced Network (“iDEN”) network, etc. The connections between the devices 105-125 and the network 130 are, for example, wired connections, wireless connections, or a combination of wireless and wired connections. Similarly, the connections between the servers 135, 140 and the network 130 are wired connections, wireless connections, or a combination of wireless and wired connections.

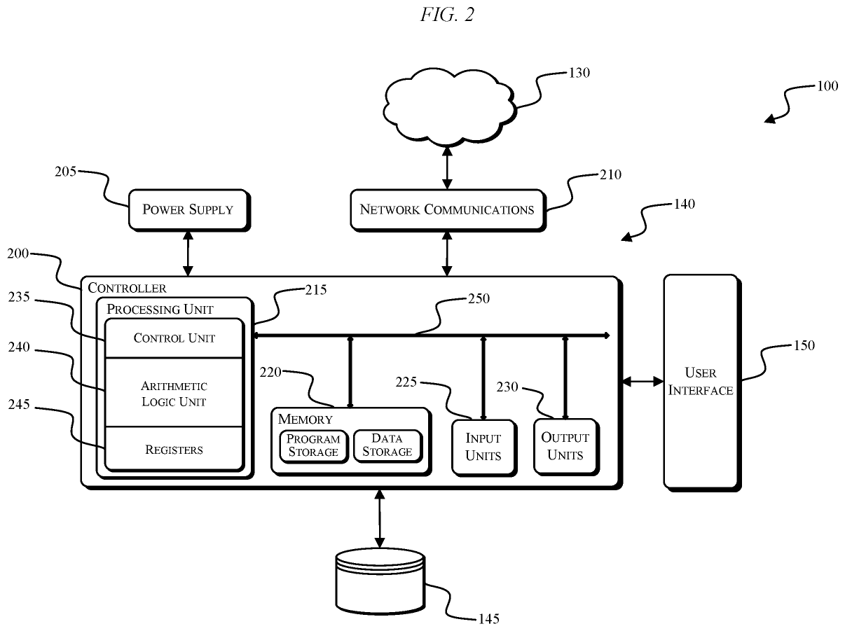

FIG. 2 illustrates the server-side of the system 100 with respect to the server 140. The server 140 is electrically and/or communicatively connected to a variety of modules or components of the system 100. For example, the server 140 is connected to the database 145 and the user interface 150. The server 140 includes a controller 200, a power supply module 205, and a network communications module 210. The controller 200 includes combinations of hardware and software that are operable to, for example, generate and/or execute fraud detection rules to detect fraudulent activity on a website, identify known users, etc. The controller 200 includes a plurality of electrical and electronic components that provide power and operational control to the components and modules within the controller 200 and/or the system 100. For example, the controller 200 (i.e., an electronic processor) includes, among other things, a processing unit 215 (e.g., a microprocessor, a microcontroller, or another suitable programmable device), a memory 220, input units 225, and output units 230. The processing unit 215 includes, among other things, a control unit 235, an arithmetic logic unit (“ALU”) 240, and a plurality of registers 245 (shown is a group of registers in FIG. 2) and is implemented using a known architecture. The processing unit 215, the memory 220, the input units 225, and the output units 230, as well as the various modules connected to the controller 200 are connected by one or more control and/or data buses (e.g., common bus 250). The control and/or data buses are shown schematically in FIG. 2 for illustrative purposes.

The memory 220 is a non-transitory computer readable medium and includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, electronic memory devices, or other data structures. The processing unit 215 is connected to the memory 220 and executes software instructions that are capable of being stored in a RAM of the memory 220 (e.g., during execution), a ROM of the memory 220 (e.g., on a generally permanent basis), or another non-transitory computer readable data storage medium such as another memory or a disc.

In some embodiments, the controller 200 or network communications module 210 includes one or more communications ports (e.g., Ethernet, serial advanced technology attachment [“SATA”], universal serial bus [“USB”], integrated drive electronics [“IDE”], etc.) for transferring, receiving, or storing data associated with the system 100 or the operation of the system 100. In some embodiments, the network communications module 210 includes an application programming interface (“API”) for the server 140 (e.g., a fraud detection API). Software included in the implementation of the system 100 can be stored in the memory 220 of the controller 200. The software includes, for example, firmware, one or more applications, program data, filters, rules, one or more program modules, and other executable instructions. The controller 200 is configured to retrieve from memory and execute, among other things, instructions related to the control methods and processes describe herein. In some embodiments, the controller 200 includes a plurality of processing units 215 and/or a plurality of memories 220 for retrieving from memory and executing the instructions related to the control methods and processes describe herein.

The power supply module 205 supplies a nominal AC or DC voltage to the controller 200 or other components or modules of the system 100. The power supply module 205 is powered by, for example, mains power having nominal line voltages between 100V and 240V AC and frequencies of approximately 50-60 Hz. The power supply module 205 is also configured to supply lower voltages to operate circuits and components within the controller 200 or system 100.

The user interface 150 includes a combination of digital and analog input or output devices required to achieve a desired level of control and monitoring for the system 100. For example, the user interface 150 includes a display (e.g., a primary display, a secondary display, etc.) and input devices such as a mouse, touch-screen displays, a plurality of knobs, dials, switches, buttons, etc.

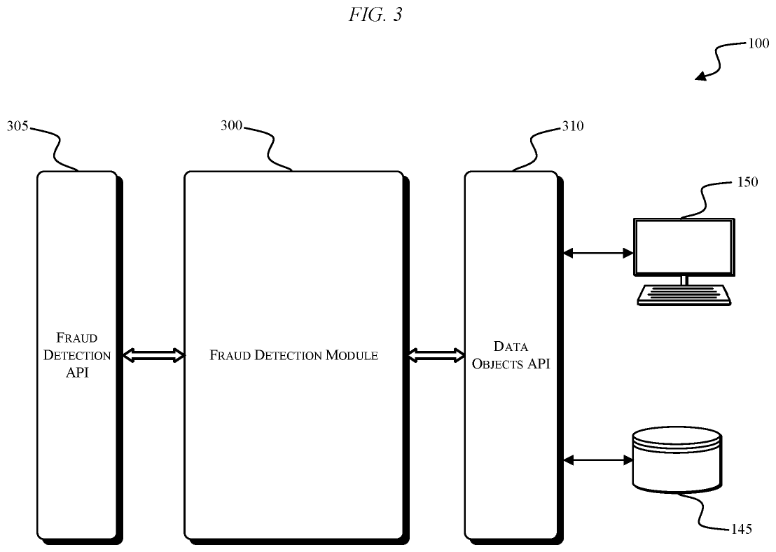

The controller 200 can include various modules and submodules related to implementing the fraud detection system 100. For example, FIG. 3 illustrates the system 100 including the database 145, the workstation 150, a fraud detection module 300, a fraud detection API 305, and a data objects API 310. After one of the devices 105-125 initiates a transaction, a fraud analysis request related to the transaction can be received by the fraud detection API 305. The fraud detection module 300 is configured to execute, for example, instructions related to determining if the transaction was initiated by a known user. The data objects API 310 operates as an interface layer between data used for known user identification and the rules that are executed by the fraud detection module 300 to perform known user identification.

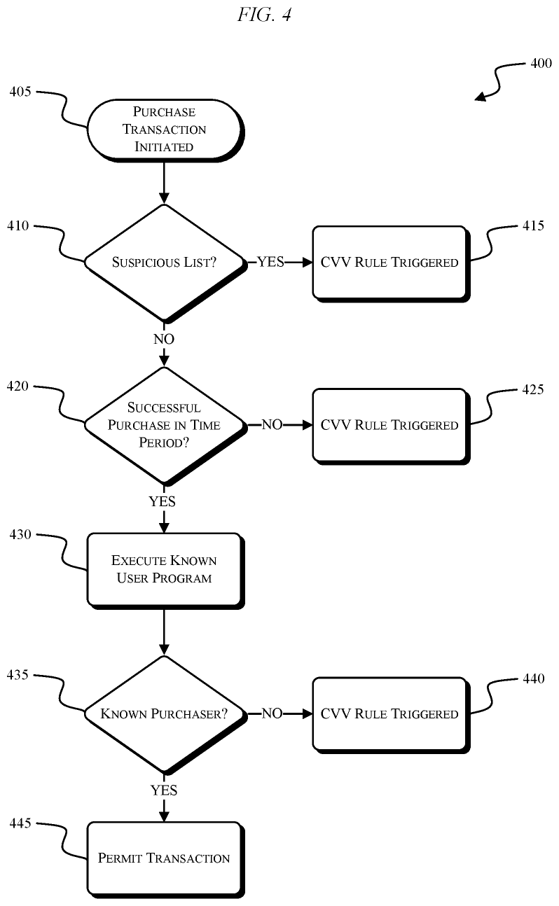

FIG. 4 illustrates a process 400 for performing known user identification. The process 400 begins with a purchase transaction being initiated (STEP 405). The fraud detection module 300 is configured to receive information related to the initiated transaction and determine whether the information appears on a suspicious user list (STEP 410). For example, the received information includes an IP address, a device identification, and an account ID. When these pieces of information are compared against suspicious user lists (e.g., stored in database 145) and a match is found, the fraud detection module 300 can flag the transaction as being related to a suspicious user and a fraud detection rule (e.g., a card verification value [“CVV”] rule) is triggered (STEP 415). The person who initiated the transaction can then be required to enter a correct CVV in order for the transaction to proceed.

If none of the IP address, device identification, or account ID is found in a suspicious user list, the fraud detection module 300 is configured to determine whether a successful purchase for the credit card was completed within a predetermined time period (STEP 420). In some embodiments, the predetermined time period is approximately 18 months. In other embodiments, different time periods are used (e.g., 12 months, 6 months, etc.). If no successful transactions related to the credit card have been completed within the time period, the CVV rule is triggered (STEP 425). The person who initiated the transaction can then be required to enter a correct CVV in order for the transaction to proceed.

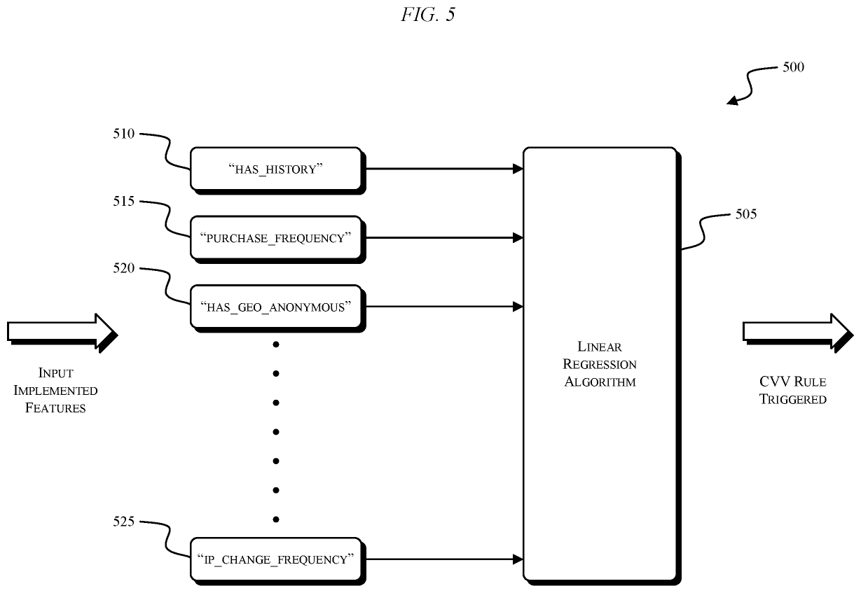

If, at STEP 430, the credit card has been used to successfully complete a transaction within the time period, a known user program is executed by the fraud detection module 300. The known user program or algorithm is described in greater detail with respect to FIG. 5. If, however, the result of the known user program is that the user who initiated the transaction is not a known user, the CVV rule is triggered (STEP 440). The person who initiated the transaction can then be required to enter a correct CVV in order for the transaction to proceed. However, if the result of the known user program is that the user is a known user, the transaction can be permitted (STEP 445) based on having identified the user as a known user and without requiring a correct CVV to be entered. In some embodiments, STEPS 410-425 of the process are skipped and an initiated transaction causes the execution of the known user program directly at STEP 430. For example, STEPS 410 and 420 can be incorporated into a known user identification linear regression algorithm.

Known user identification can be completed using, for example, a decision tree for which a series of IF-THEN statements are used to determine if a user is a known user. Examples of such IF-THEN statements that would trigger a fraud rule (e.g., requiring a CVV) are provided below:

IF geo_anonymous=1 & cloud_hosting_ip=1 & endpoint_change_frequency > 10 THEN Fraud
IF tor_exit_node=1 & daily_purchase+frequency > 1 THEN Fraud

Additionally or alternatively to the use of a decision tree, a known user identification linear regression algorithm or formula can be used. The linear regression formula is configured to provide an aggregated weighted score to determine whether a user is a known user or if a transaction is potentially fraudulent. A variety of features associated with an initiated transaction can be used in the linear regression formula. Each feature has a corresponding coefficient that weights the feature based on the influence that each feature has on a transaction potentially being fraudulent. A generic linear regression formula is provided below:

Probability=[Coef1]*[Feature1]+[Coef2]*[Feature2]+[Coef3]*[Feature3]+[Y-Intercept]

The generic linear regression formula provided above includes three coefficients and three features. In some embodiments, more than three coefficients are used in a linear regression formula. For example, in some embodiments, fourteen features and fourteen corresponding weighted coefficients are used in a linear regression formula. TABLE 1 provides an example list of features than can be used in a known user identification linear regression formula and/or in a decision tree.

TABLE 1
TRANSACTION FEATURES

| Category | Feature Name | Value of the Feature |
|---|---|---|
| Suspicious | is_ip_ suspicious_list | 0, 1 to indicate whether current IP |
| Lists | is_did_suspicious_list | address, device identification, or |
| | is_account_suspicious_list | account ID is in a fraud suspicious list. |
| Purchase | has_history | 0, 1 to indicate whether there is a |
| History | | successful purchase in the past n-many |
| | | weeks. |
| Existing | has_geo_anonymous | 0, 1 to indicate whether the rule has |
| Fraud | has_cloud_hosting_ip | been triggered. |
| Rules | has_tor_exit_node | |
| Purchase | purchase_frequency | Total number of successful purchases |
| Behavior | | for an account over a time period |
| | | (e.g., 1 year). |
| Endpoint | accountemaildomain_change_frequency | Total number of distinct endpoint |
| Change | email_change_frequency | values of an account ID's successful |
| Frequency | ipcarrier_change_frequency (ISP) | purchase records over a time period |
| | zipcode_change_frequency | (e.g., 1 year). |
| | browserplatform_change_frequency | |
| | ip_change_frequency (IP address) | |

In some embodiments, the has_geo_anonymous feature indicates whether the current IP address attempting to perform the transaction is associated with a proxy network/server. For example, association with a proxy network/server may indicate a heightened probability of fraud because the true origin of the transaction request may be masked by the proxy network/server. In some embodiments, the has_cloud_hosting_ip feature indicates whether the current IP carrier/Internet service provider (ISP) from which the transaction is being attempted has been previously flagged as suspicious (e.g., based on a list stored in database 145). In some embodiments, the has_tor_exit_node feature indicates whether the current IP address attempting to perform the transaction is associated with known suspicious networks such as The Onion Router (Tor).

In some embodiments, the purchase_frequency feature and the endpoint change frequency features are normalized using a total number of purchases/transactions made with the current account. For example, the purchase_frequency feature may be calculated by dividing a total number of successful purchases for an account in the past one year by an overall total number of successful purchases for the account that have ever been made. This normalized value between zero and one may be used to indicate how frequently the account has made purchases/transactions compared to historical data of the account.

Similar calculations may be made to determine the endpoint change frequency features as well. For example, the zipcode_change_frequency feature may be calculated by dividing a total number of purchases/transactions made with an account over the past one year using a first zip code 51234 by an overall total number of purchases/transactions made with the account over the past one year using any zip code. This normalized value between zero and one may be used to indicate how frequently the first zip code 51234 has been used in the past one year by the account to complete purchases/transactions. Although the above example is provided with respect to the zip code of the current transaction, similar calculations may be made to determine the other endpoint change frequency parameters. In other words, the server 140 may be configured to determine a value of an end point change frequency feature by dividing a total number of purchases made with an account associated with the current electronic transaction over a past predetermined time period using first end point information of the end point change frequency feature associated with the electronic transaction (e.g., transactions using the first zip code 51234) by an overall total number of purchases made with the account over the past predetermined time period using any end point information of the end point change frequency feature (e.g., transactions using any zip code).

FIG. 5 illustrates a diagram 500 where a linear regression algorithm or formula 505 uses the transaction features of TABLE 1 to make a determination about whether a user is a known user or whether a fraud rule will be triggered. In FIG. 5, the linear regression algorithm 505 illustratively receives the has_history feature 510, the purchase_frequency feature 515, the has_geo_anonymous feature 520, and the ip_change_frequency frequency feature 525. The linear regression algorithm 505 can also receive the other features provided in TABLE 1 and/or additional features related to a transaction.

The linear regression algorithm 505 outputs a prediction value related to whether a user is a known user or if a transaction is potentially fraudulent. If the prediction value is greater than or equal to a threshold value, the fraud rule is triggered. If the prediction value is less than the threshold value, the fraud rule is not triggered and a user is identified as a known user. In some embodiments, the threshold has a normalized value of between 0 and 1 (e.g., 0.8). An example linear regression algorithm 505 is provided below:

Prediction_Value = [has_geo_anonymous]*[0.0586] + [has_cloud_hosting_ip]*[0.030] +
[has_tor_exit_node]*[0.098] + [is_ip_suspicious_list]*[0.045] + [is_did_suspicious_list]*[0.213]
+ [is_account_suspicious_list]*[0.526] + [has_history]*[0.084] + [purchase_frequency]*[0.110]
+ [accountemaildomain_change_frequency]*[0.667] + [email_change_frequency]*[0.139] +
[ipcarrier_change_frequency]*[0.092] + [zipcode_change_frequency]*[0.071] +
browserplatform_change_frequency]*[0.031] + [ip_change_frequency]*[0.001] − 0.0999.

For the linear regression algorithm provided above, a Y-intercept of −0.0999 is used. In some embodiments, the Y-intercept of the linear regression algorithm can be set to a different value. Similarly, the weights/values of one or more of the coefficients of the transaction features in the linear regression algorithm provided above may be set to different values in some embodiments. If the Prediction_Value that results from the linear regression algorithm is greater than or equal to the threshold value (e.g., 0.8), the fraud rule is triggered (i.e., predicted fraud). If the Prediction_Value that results from the linear regression algorithm is less than the threshold value, the user who initiated the transaction is identified as a known user and the transaction is permitted to proceed (i.e., predicted non-fraud).

Thus, embodiments described herein provide, among other things, systems, methods, devices, and computer readable media for determining whether a transaction was initiated by a known user.

What is claimed is:

1. A fraud detection system comprising:
a database; and
a server connected to the database, the server configured to determine whether an electronic transaction was initiated by a known user, the server including an electronic processor and a memory, the server configured to:
receive a fraud analysis request related to the electronic transaction, the electronic transaction including an associated plurality of features,
determine values for the plurality of features for the electronic transaction,
apply a weighted coefficient to each of the values of the plurality of features, the weighted coefficients related to an influence that each respective feature has on the electronic transaction potentially being a fraudulent transaction,
determine a fraud prediction value based on the values of the plurality of features and the weighted coefficients,
compare the fraud prediction value to a threshold value, and
identify a user who initiated the electronic transaction as a known user when the fraud prediction value is less than the threshold value.

2. The fraud detection system of claim 1, wherein the server is configured to:
determine that the fraud prediction value is greater than the threshold value; and
in response to determining that the fraud prediction value is greater than the threshold value, trigger a fraud detection rule to be completed successfully in order to permit the electronic transaction.

3. The fraud detection system of claim 2, wherein the fraud detection rule includes a card verification value (CVV) that must be correctly entered for the electronic transaction to be permitted.

4. The fraud detection system of claim 1, wherein the electronic transaction is associated with an Internet Protocol (IP) address, a device identification, and an account identification; and
wherein the server is configured to:
determine whether at least one of the IP address, the device identification, and the account identification is on a suspicious user list stored in the database,
in response to determining that at least one of the IP address, the device identification, and the account identification is on the suspicious user list, trigger a fraud detection rule to be completed successfully in order to permit the electronic transaction, and
in response to determining that none of the IP address, the device identification, and the account identification are on the suspicious user list, determine whether the electronic transaction was initiated by a known user.

5. The fraud detection system of claim 1, wherein the server is configured to:
determine whether a successful purchase for an account associated with the electronic transaction has been completed within a past predetermined time period;
in response to determining that no successful purchases for the account have been completed within the past predetermined time period, trigger a fraud detection rule to be completed successfully in order to permit the electronic transaction; and
in response to determining that at least one successful purchase for the account has been completed within the past predetermined time period, determine whether the electronic transaction was initiated by a known user.

6. The fraud detection system of claim 1, wherein the associated plurality of features includes at least three features each selected from a different category of features, the different categories of features including a suspicious list category, a purchase history category, an existing fraud rules category, a purchase behavior category, and an end point change frequency category.

7. The fraud detection system of claim 1, wherein at least one feature of the associated plurality of features includes an end point change frequency feature; and
wherein the server is configured to determine a value of the end point change frequency feature by dividing a total number of purchases made with an account associated with the electronic transaction over a past predetermined time period using first end point information of the end point change frequency feature associated with the electronic transaction by an overall total number of purchases made with the account over the past predetermined time period using any end point information of the end point change frequency feature.

8. A method for detecting fraud during an electronic transaction by determining whether the electronic transaction was initiated by a known user, the method comprising:
receiving, with a server, a fraud analysis request related to the electronic transaction, the electronic transaction including an associated plurality of features, the server connected to a database and including an electronic processor and a memory;
determining, with the server, values for the plurality of features for the electronic transaction;
applying, with the server, a weighted coefficient to each of the values of the plurality of features, the weighted coefficients related to an influence that each respective feature has on the electronic transaction potentially being a fraudulent transaction;
determining, with the server, a fraud prediction value based on the values of the plurality of features and the weighted coefficients;
comparing, with the server, the fraud prediction value to a threshold value; and
identifying, with the server, a user who initiated the electronic transaction as a known user when the fraud prediction value is less than the threshold value.

9. The method of claim 8, further comprising:
determining, with the server, that the fraud prediction value is greater than the threshold value; and
in response to determining that the fraud prediction value is greater than the threshold value, triggering, with the server, a fraud detection rule to be completed successfully in order to permit the electronic transaction.

10. The method of claim 9, wherein triggering the fraud detection rule includes triggering a card verification value (CVV) that must be correctly entered for the electronic transaction to be permitted.

11. The method of claim 8, wherein the electronic transaction is associated with an Internet Protocol (IP) address, a device identification, and an account identification, and further comprising:
determining, with the server, whether at least one of the IP address, the device identification, and the account identification is on a suspicious user list stored in the database;
in response to determining that at least one of the IP address, the device identification, and the account identification is on the suspicious user list, triggering, with the server, a fraud detection rule to be completed successfully in order to permit the electronic transaction; and
in response to determining that none of the IP address, the device identification, and the account identification are on the suspicious user list, determining whether the electronic transaction was initiated by a known user.

12. The method of claim 8, further comprising:
determining, with the server, whether a successful purchase for an account associated with the electronic transaction has been completed within a past predetermined time period;
in response to determining that no successful purchases for the account have been completed within the past predetermined time period, triggering, with the server, a fraud detection rule to be completed successfully in order to permit the electronic transaction; and
in response to determining that at least one successful purchase for the account has been completed within the past predetermined time period, determining, with the server, whether the electronic transaction was initiated by a known user.

13. The method of claim 8, wherein the associated plurality of features includes at least three features each selected from a different category of features, the different categories of features including a suspicious list category, a purchase history category, an existing fraud rules category, a purchase behavior category, and an end point change frequency category.

14. The method of claim 8, wherein at least one feature of the associated plurality of features includes an end point change frequency feature, and further comprising:
determining, with the server, a value of the end point change frequency feature by dividing a total number of purchases made with an account associated with the electronic transaction over a past predetermined time period using first end point information of the end point change frequency feature associated with the electronic transaction by an overall total number of purchases made with the account over the past predetermined time period using any end point information of the end point change frequency feature.

15. At least one non-transitory computer-readable medium having encoded thereon instructions which, when executed by at least one electronic processor, cause the at least one electronic processor to perform a method for detecting fraud during an electronic transaction by determining whether the electronic transaction was initiated by a known user, the method comprising:
receiving, with a server, a fraud analysis request related to the electronic transaction, the electronic transaction including an associated plurality of features, the server connected to a database and including an electronic processor and a memory;
determining, with the server, values for the plurality of features for the electronic transaction;
applying, with the server, a weighted coefficient to each of the values of the plurality of features, the weighted coefficients related to an influence that each respective feature has on the electronic transaction potentially being a fraudulent transaction;
determining, with the server, a fraud prediction value based on the values of the plurality of features and the weighted coefficients;
comparing, with the server, the fraud prediction value to a threshold value; and
identifying, with the server, a user who initiated the electronic transaction as a known user when the fraud prediction value is less than the threshold value.

16. The at least one non-transitory computer-readable medium of claim 15, wherein the method further comprises:
determining, with the server, that the fraud prediction value is greater than the threshold value; and
in response to determining that the fraud prediction value is greater than the threshold value, triggering, with the server, a fraud detection rule to be completed successfully in order to permit the electronic transaction.

17. The at least one non-transitory computer-readable medium of claim 16, wherein triggering the fraud detection rule includes triggering a card verification value (CVV) that must be correctly entered for the electronic transaction to be permitted.

18. The at least one non-transitory computer-readable medium of claim 15, wherein the electronic transaction is associated with an Internet Protocol (IP) address, a device identification, and an account identification, and wherein the method further comprises:
determining, with the server, whether at least one of the IP address, the device identification, and the account identification is on a suspicious user list stored in the database;
in response to determining that at least one of the IP address, the device identification, and the account identification is on the suspicious user list, triggering, with the server, a fraud detection rule to be completed successfully in order to permit the electronic transaction;
in response to determining that none of the IP address, the device identification, and the account identification are on the suspicious user list, determining, with the server, whether a successful purchase for an account associated with the electronic transaction has been completed within a past predetermined time period;
in response to determining that no successful purchases for the account have been completed within the past predetermined time period, triggering, with the server, the fraud detection rule to be completed successfully in order to permit the electronic transaction; and
in response to determining that at least one successful purchase for the account has been completed within the past predetermined time period, determining, with the server, whether the electronic transaction was initiated by a known user.

19. The at least one non-transitory computer-readable medium of claim 15, wherein the associated plurality of features includes at least three features each selected from a different category of features, the different categories of features including a suspicious list category, a purchase history category, an existing fraud rules category, a purchase behavior category, and an end point change frequency category.

20. The at least one non-transitory computer-readable medium of claim 15, wherein at least one feature of the associated plurality of features includes an end point change frequency feature, and wherein the method further comprises:
determining, with the server, a value of the end point change frequency feature by dividing a total number of purchases made with an account associated with the electronic transaction over a past predetermined time period using first end point information of the end point change frequency feature associated with the electronic transaction by an overall total number of purchases made with the account over the past predetermined time period using any end point information of the end point change frequency feature.
